(19) United States
(12) Patent Application Publication
(10) Pub. No.: US 2003/0115059 A1
(43) Pub. Date: Jun. 19, 2003

(54) Real time translator and method of performing real time translation of a plurality of spoken languages

(76) Inventor: Neville Jayaratne, Brighton Victoria (AU)

Correspondence Address: TIMOTHY J MARTIN, PC, 9250 W 5TH AVENUE, SUITE 200, LAKEWOOD, CO, 80226, US

(21) Appl. No.: 10/081,773

(22) Filed: Feb. 20, 2002

(30) Foreign Application Priority Data
Dec. 17, 2001 (AU) PR9569

(51) Int. Cl. G10L 15/26

(52) U.S. Cl. 704/235

(57) ABSTRACT

A real time translator (101) having a voice receiver or microphone (101), a voice to text converter (102), a text-to-text spoken language translator (103) for receiving a first language and translating to a second selected language, a text to speech converter (105) for converting the translated second selected language to a voice output and a voice emitter or speaker (211) for emitting the voice output. A second voice receiver or microphone (201), a voice to text converter (202), a text-to-text spoken language translator (203) for receiving a second language and translating to the first selected language, a text to speech converter (105) for converting the translated first selected language to a voice output and a voice emitter or speaker (111) for emitting the voice output. There is parallel processing of the voice to text conversion and/or text translation and/or the text to voice conversion. Two sound cards (151, 152), or two channels (151A, 151B) operating separately on a sound card (151), interface with the first and second voice receivers (101, 201) and first and second voice emitters (111,211) The parallel processing can be by central processing unit (cpu) parallel processing techniques or by software controlled switching techniques.

### FIELD OF THE INVENTION

This invention relates to a real time translator for providing multi language “spoken word” communication, conversation, and/or dialogue, conferencing and public address system. It is particularly related to a multilanguage conversation translator for the tourist, business or professional translation but is not limited to such use.

### BACKGROUND OF THE INVENTION

Arguably, the greatest ability the human race possesses is that of communication via sophisticated languages that have evolved over time. However, it is also the biggest barrier currently facing humankind. Even as the word “globalisation” is frequently used these days in the field of trade and business as well as many other areas of interaction between the different peoples of the world, the main “obstacle” to achieving true globalisation are language barriers. This limits the ability to communicate & converse one-on-one between people who converse through one of the many different languages.

Translations are required in a number of situations including:

The tourist in a foreign country where he does not speak the language struggles to make himself understood for the most basic of requirements like asking for directions or making a purchase.

The businessperson at the end of a telephone line trying to make conversation with either a potential client or business colleague in another country when he does not speak the language.

The speaker wanting to address and communicate with an audience that speaks a different language in a conference or broadcast situation.

Translators though must be created with regard to the basic architecture of a typical spoken language translation or natural language processing system processes sounds produced by a speaker by converting them into digital form using an analogue-to-digital converter. This signal is processed to extract various features, such as the intensity of sound at different frequencies and the change in intensity over time. These features serve as the input to a speech recognition system, which generally uses Hidden Markov Model (HMM) techniques to identify the most likely sequence of words that could have produced the speech signal. The speech recogniser outputs the most likely sequence of words to serve as input to a natural language processing system. When the natural language processing system needs to generate an utterance, it passes a sentence to a module that translates the words into phonemic sequence and determines an intonational contour, and passes this information on to a speech synthesis system, which produces the spoken output.

Most translators look at the difficulties in the translations of the spoken languages, translate back to written word, and perform detailed analysis of the written based on a number of rules and categories of translation.

A natural language processing system uses considerable knowledge about the structure of the language, including what the words are, how words combine to form sentences, what the words mean, and how word meanings contribute to sentence meanings. However, linguistic behaviour cannot be completely accounted for without also taking into account another aspect of what makes humans intelligent—their general world knowledge and their reasoning abilities. For example, to answer questions or to participate in a conversation, a person not only must have knowledge about the structure of the language being used, but also must know about the world in general and the conversational setting.

The different forms of knowledge relevant for natural language processing comprise phonetic and phonological knowledge, morphological knowledge, syntactic knowledge, semantic knowledge, and pragmatic knowledge. Phonetic and phonological knowledge concerns how words are related to the sounds that realize them. Such knowledge is crucial for speech-based systems. Morphological knowledge concerns how words are constructed from basic units called morphemes. A morpheme is the primitive unit in a language; for example, the word friendly is derivable from the meaning of the noun friend and the suffix “-ly”, which transforms a noun into an adjective.

Syntactic knowledge concerns how words can be put together to form correct sentences and determines what structural role each word plays in the sentence and what phrases are subparts of what other phrases. Typical syntactic representations of language are based on the notion of context-free grammars, which represent sentence structure in terms of what phrases are subparts of other phrases. This syntactic information is often presented in a tree form.

Semantic knowledge concerns what words mean and how these meanings combine in sentences to form sentence meanings. This is the study of context-independent meaning—the meaning a sentence has regardless of the context in which it is used. The representation of the context-independent meaning of a sentence is called its logical form. The logical form encodes possible word senses and identifies the semantic relationships between the words and phrases.

Natural language processing systems further comprise interpretation processes that map from one representation to the other. For instance, the process that maps a sentence to its syntactic structure and logical form is called parsing, and it is performed by a component called a parser. The parser uses knowledge about word and word meaning, the lexicon, and a set of rules defining the legal structures, the grammar, in order to assign a syntactic structure and a logical form to an input sentence. Formally, a context-free grammar of a language is a quadruple comprising non-terminal vocabularies, terminal vocabularies, a finite set of production rules, and a starting symbol for all productions. The non-terminal and terminal vocabularies are disjoint. The set of terminal symbols is called the vocabulary of the language. Pragmatic knowledge concerns how sentences are used in different situations and how use affects the interpretation of the sentence.

The typical natural language processor, however, has realized only limited success because these processors operate only within a narrow framework. A natural language processor receives an input sentence, lexically separates the words in the sentence, syntactically determines the types of words, semantically understands the words, pragmatically determines the type of response to generate, and generates the response. The natural language processor employs many types of knowledge and stores different types of knowledge in different knowledge structures that separate the knowledge into organized types. A typical natural language processor also uses very complex capabilities. The knowledge and capabilities of the typical natural language processor must be reduced in complexity and refined to make the natural language processor manageable and useful because a natural language processor must have more than a reasonably correct response to an input sentence.

Identified problems with previous approaches to natural language processing are numerous and involve many components of the typical speech translation system. Regarding the spoken language translation system, one previous approach combines the syntactic rules for analysis together with the transfer patterns or transfer rules. As a result, the syntactic rules and the transfer rules become inter-dependent, and the system becomes less modular and difficult to extend in coverage or apply to a new translation domain.

In U.S. Pat. No. 6,266,642 to Sony Corporation there is provided a method and portable apparatus for performing spoken language. However this involves the step of recognising at least one source expression of the at least one source language, wherein recognising the at least one source expression comprises operating on the at least one speech input to produce an intermediate source language data structure, producing at least one source recognition hypothesis from the intermediate data structure using a model, identifying a best source recognition hypothesis from among the at least one source recognition hypothesis and generating the at least one source expression from the best source recognition hypothesis. Clearly, this involves the detailed computer analysis and is not readily available for a portable or conversation translator.

U.S. Pat. No. 6,278,968 also describes a detailed large computer translator. The described invention relates to translating from one language to another. More particularly, the described invention relates to providing translation between languages based, at least in part, on a user selecting a particular topic that the translation focuses on. In this way, the translator is limited and not able to provide a true conversation translator.

Therefore, few translators look at the physical hardware and flow path to provide a portable conversation real time translator.

It is noted that U.S. Pat. No. 6,266,642 claims to provide a portable apparatus with embodiments of the invention comprising a portable unit that performs a method for spoken language translation. One such embodiment is a laptop computer, while another such embodiment is a cellular telephone. Portable embodiments may be self contained or not self-contained. Self-contained portable embodiments include hardware and software for receiving a natural spoken language input, performing translation, performing speech synthesis on the translation, and outputting translated natural spoken language. Embodiments that are not self-contained include hardware and software for receiving natural spoken language input, digitising the input, and transmitting the digitised input via various communication methods to remote hardware and software which performs translation. The translation is returned by the remote hardware and software to the portable unit, where it is synthesized for presentation to the user as natural spoken language.

However, the structure of such translators only allows for one-way communication and therefore is not a portable translator suitable for two-way conversation.

### SUMMARY OF THE INVENTION

The aim of the invention is to provide an electronic solution to the language barrier between languages for the spoken word.

Broadly the invention provides a multilanguage conversation translator having dual voice paths operated by one or more sound cards and software so that conversation from one person in one spoken word language is translated and received by a second person in a second spoken word language at the same time or substantially at the same time as conversation from the second person in the second spoken word language is translated and received by the first person whereby the two persons can undertake a normal conversation in normal time but in different spoken word languages.

The translator can be portable or hand-held with inbuilt or attached headset or the like. Other versions of the system can be attached to the telephone system or attached to a personal address system or the like.

In accordance with the invention there is provided a real time translator comprising:

(a) a voice receiver;

(b) a voice to text converter;

(c) a text-to-text spoken language converter for receiving a first language and translating to a second selected language;

(d) a text to voice converter for converting the translated second selected language to a voice output; and

(e) a voice emitter for emitting the voice output.

In one form of the invention there is provided a real time translator comprising:

(a) at least one voice receiver;

(b) at least one voice to text converter;

(c) at least one text to text spoken language converter for receiving a first selected language text and translating to a second selected language text and/or for receiving the second selected language text and translating to the first selected language text;

(d) at least one text to voice converter for converting the translated first and/or second selected language to a voice output; and

(e) at least one voice emitter for emitting the voice outputs.

The real time translator could include two sound paths formed by two separate electronic sound manipulators with associated software such that the sound of the first voice in first language being received can be converted to text while the translated text into the second selected language is being converted to voice by the second separate electronic sound manipulator with associated software. The separate electronic sound manipulators may be two personal computer sound cards or the like, or two separate left and right channels of a single personal computer sound card or the like with separate software control.

In a particular preferred form of the invention there is provided a portable real time translator comprising

(a) first and second voice receivers for receiving first and second selected voice languages;

(b) first and second voice to text converters;

(c) at least one text to text spoken language converter for receiving a first selected language text and translating to a second selected language text and/or for receiving the second selected language text and translating to the first selected language text;

(d) first and second voice converters for converting the translated first and second selected language to first and second voice outputs; and

(e) first and second voice emitters for emitting the voice outputs.

There is a “response time” in the processing of conversion of first and second voice conversions to or from text and/or with text to text voice language translation such that the lag time between receiving voice and emitting translated voice is within a reasonable conversation period. Such period can be less than one second to a maximum of two seconds. Further to simulate conversation the voice translation and emission is in voice phrases substantially corresponding with voice phrasing of input voice such that a continual flow of spaced voice phrases simulates conversations. Generally, such voice phrases are a sentence or part of a sentence.

Still further there may be an “overlap” in processing such that a first voice in a first language is received and translated and emitting translated voice simultaneously or apparently simultaneously with receiving a second voice in a second language and translating and emitting second translated voice. This can be by separate processing paths including the separate personal computer sound cards or the like or separate channels on a sound card or the like or by a switching system for switching between two processing paths at a rate to maintain reasonable real time processing of both paths simultaneously.

The invention also provides a method of providing real time translation of voices. The method includes:

(a) providing first and second voice receivers for receiving first and second selected voice languages;

(b) providing first and second voice emitters associated with the first and second voice receivers respectively for emitting voice outputs;

(c) converting said first and second selected voice languages from said first and second voice receivers to text;

(d) providing a text to text spoken language converter for receiving a first selected language text from said first voice receiver and translating to a second selected language text and/or for receiving the second selected language text and translating to the first selected language text;

(e) providing a voice converter for converting the translated first and second selected language to first and second voice outputs; and

(f) emitting said translated and converted first and second voice outputs.

There is parallel processing of the voice to text conversion and/or text translation and/or the text to voice conversion. Two sound cards or two channels operating separately on a sound card can provide the first and second voice receivers and first and second voice emitters. Processing of the voice to text conversion and/or text translation and/or the text to voice conversion is by a central processing unit (cpu) or the like with software control of the sound card/s. The parallel processing can be by central processing unit (cpu), parallel processing techniques but primarily by parallel processing via software controlled switching techniques. Therefore both paths are always operating bi-directional both ways to provide conversation.

The software has to overcome the difficulty that another later installed sound cards will generally override a single sound card-operating environment in normal uses. The software overcomes this predetermined intent and the unusual parallel operation of two sound cards in a parallel operation of software controlled switching between the speed of a voice phrase of between less than one second to a maximum 2 seconds to the megahertz speed of the central processing unit (cpu).

This invention provides a practical solution to enable:

(1) a conversation and/or dialogue (which is relatively immediate, instant and on-the-spot) between two persons or groups wishing to communicate by conversing in two different languages either face-to-face or over a telephone line (or similar); and

(2) a speaker to communicate by addressing an audience in a language that is different to that of the audience

(3) the audience to respond with comments and questions to the speaker.

The main applications that can use the disclosed translator are the three scenarios of:

1. Person-to-person conversation and/or dialogue in two different languages at any one instance enabling a face-to-face conversation or dialogue (type method of communication) between speakers of two different languages.

2. Person-to-person or party-to-party conversation and/or dialogue via a telephone line (or similar) in two different languages at any one instance enabling a remote conversation or dialogue (type of communication) between speakers of two different languages.

3. Person to many in a lecture, conferencing, or public addressing System from one language to a different language at any one instance enabling a one-to-many communication between a speaker and audience in two different languages.

The invention provides an innovative and practical solution to the above scenarios providing the ability to communicate (speak) in language-A and be understood (heard) in language-B—immediately, instantly and “on the spot”. With the ability in reverse to communicate (reply back) in language-B and be understood (heard) in language-A. As in the first two scenarios the ability to have a real-time conversation/dialogue in two different languages. In the third scenario the ability to communicate by “addressing” or “to inform” in one language but be understood (heard) in a different language and to receive response from the audience in the form of comments or questions.

### BRIEF DESCRIPTION OF THE DRAWINGS

In order that the invention may be more readily understood, an embodiment will be described by way of illustration only with reference to the drawings wherein:

FIG. 1 is a flow chart of a real time translator in accordance with a first embodiment of the invention;

FIG. 2 is a diagrammatic representation of a real time translator of FIG. 1;

FIG. 3 is a diagrammatic representation of a first use of a real time translator in accordance with the invention;

FIG. 4 is a diagrammatic representation of a second use of a real time translator in accordance with the invention;

FIG. 5 is a diagrammatic representation of a third use of a real time translator in accordance with the invention;

### DETAILED DESCRIPTION OF A PREFERRED EMBODIMENT OF PERFORMING THE INVENTION

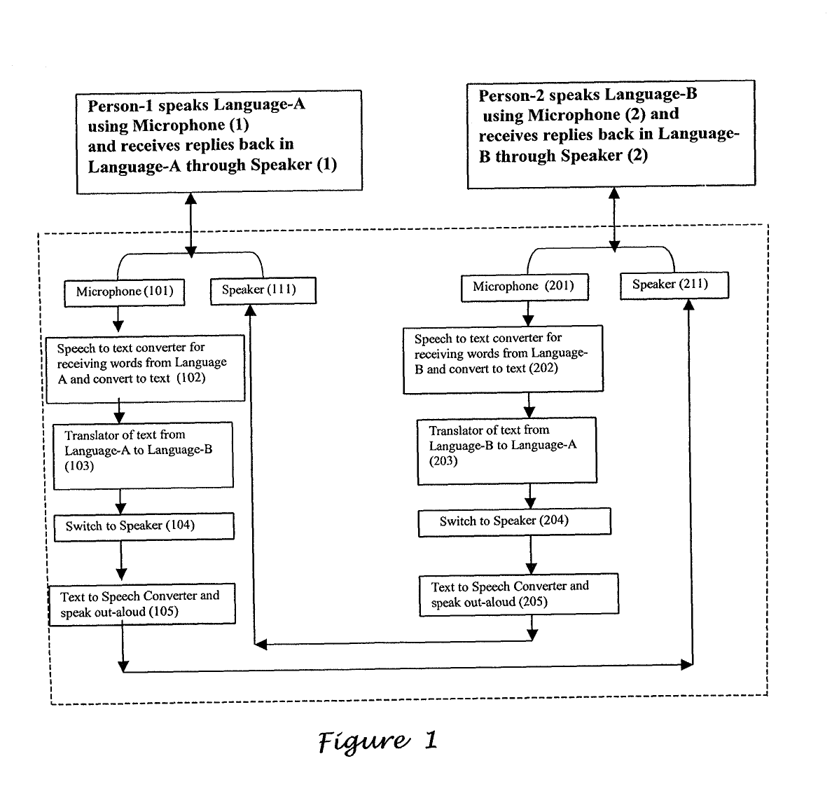

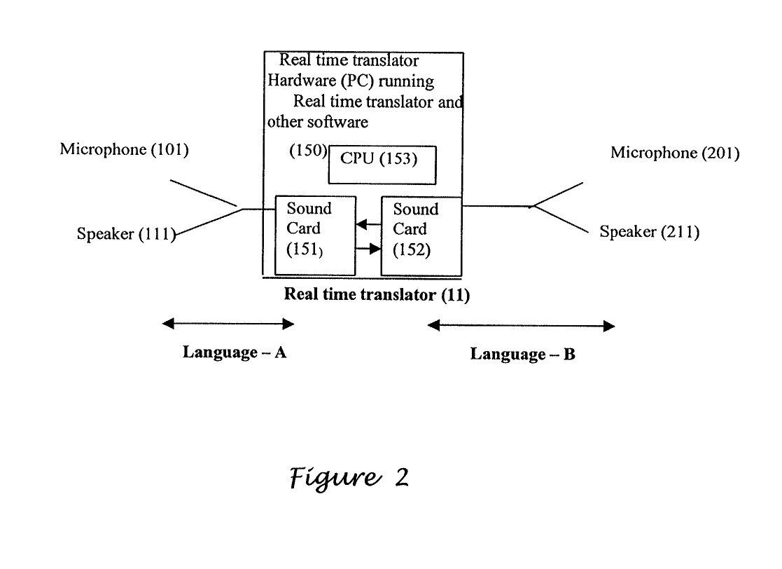

Referring to the drawings and particularly FIGS. 1 and 2 there is shown in accordance with the invention a real time translator (101) having a voice receiver or microphone (101), a voice to text converter (102), a text-to-text spoken language translator (103) for receiving a first language and translating to a second selected language, a text to speech converter (105) for converting the translated second selected language to a voice output and a voice emitter or speaker (211) for emitting the voice output.

Further there is shown in accordance with the invention the real time translator (101) having a second voice receiver or microphone (201), a voice to text converter (202), a text-to-text spoken language translator (203) for receiving a second language and translating to the first selected language, a text to speech converter (105) for converting the translated first selected language to a voice output and a voice emitter or speaker (111) for emitting the voice output.

There is parallel processing of the voice to text conversion and/or text translation and/or the text to voice conversion. Two sound cards (151, 152), or two channels (151A, 151B) operating separately on a sound card (151), interface with the first and second voice receivers (101, 201) and first and second voice emitters (111,211). Processing of the voice to text conversion and/or text translation and/or the text to voice conversion is by a central processing unit (cpu) or the like with software control of the sound card/s (151,152). The parallel processing can be by central processing unit (cpu) parallel processing techniques or by software controlled switching techniques.

The real time translator (101) includes two sound paths formed by two separate electronic sound manipulators with associated software such that the sound of the first voice in first language being received can be converted to text while the translated text into the second selected language is being converted to voice by the second separate electronic sound manipulator with associated software. This is provided by the separate electronic sound manipulators of the two personal computer sound cards (151,152) or the like, or two separately operated left and right channels (151A, 151B) of a single personal computer sound card (151 ) or the like with separate software control.

There is a “response time” in the processing of conversion of first and second voice conversions to or from text and/or with text to text voice language translation such that the lag time between receiving voice and emitting translated voice is within a reasonable conversation period. Such period can be less than one second to a maximum of two seconds. Further to simulate conversation the voice translation and emission is in voice phrases substantially corresponding with voice phrasing of input voice such that a continual flow of spaced voice phrases simulates conversations. Generally, such voice phrases are a sentence or part of a sentence.

Still further there is an “overlap” in processing such that a first voice in a first language is received and translated and emitting translated voice simultaneously or apparently simultaneously with receiving a second voice in a second language and translating and emitting second translated voice. This can be by separate processing paths including the separate personal computer sound cards or the like or separate channels on a sound card or the like or by a switching system for switching between two processing paths at a rate to maintain reasonable real time processing of both paths simultaneously.

The essence of the invention is to enable a conversation/dialogue between two different languages and as such the invention remains unchanged irrespective of the languages in which the conversation or dialogue is conducted in. Conversation between the following languages will include English, Korean, French, Simplified Chinese, Traditional Chinese, Italian, German, Spanish, and Japanese.

The technical methodology behind the invention includes three (3) basic steps:

1. Receive the input-source of the spoken word and/or sentence via a channel of input (eg input source-one) such as a microphone or via a telephone line and convert to written text.

2. Translate the text from one language to another.

3. Speak out the translated text converted back to speech via an output channel (output source-two) such as a speaker from a headphone, telephone, or other.

Step-1 Receive Spoken Word or Sentence via an Input Source

When words are spoken into microphone (101), it is made active and received as input. Words spoken in language-A is received via microphone (101) and converted to text. Words of language-A (in text format) are translated within real time translator (150) to language-B (also in text format). Real time translator switches (104) focus to speaker (211) and, the text of the words of language-B is converted to speech and “spoken out” through speaker (211).

Words spoken in reply or any words spoken in language-B is received via microphone (201) and converted to text. Words of language-B (in text format) are translated within real time translator (150) to language-A (also in text format). Real time translator (150) switches focus to speaker (111) and, the text from the words of language-A is converted to speech and “spoken out” through speaker (111). All of the above happens instantly, immediately and “on-the-spot” enabling a real-time conversation/dialogue between two different languages.

Real time translator software (160) is invoked based on input from one of the two voice input sources (101,201) and will receive the input-source of the “spoken word” and/or “sentence” via a channel of input such as a microphone or via a telephone line, spoken by person-1 in language A.

As shown in the hardware configuration as detailed below, the invention works based on software-controlled operation of two sound cards or through software, that utilises the operating system aspects of the “left & right” channel (151A, 151B) capability of a single sound card (151).

However, the preferred embodiment has the two sound cards plus software method. With either of these two methods, the invention of real time translator (150) is based on receiving spoken words from voice input devices such as.

(1) From a microphone (of a headset or single microphone).

(2) From a telephone line.

(3) From a conference or public announcement/speaker system.

The spoken word or sentence is converted to text for translation The preferred embodiment uses software package ViaVoice™ software package of IBM™, which is specifically marketed and sold for the development of voice recognition applications. However, any similar voice recognition software, of which there are several on the market, can be used or similar software can be written. Either way, the real time translator software (160) remains unchanged.

Step-2 Translate the Text

The input source of words/sentence that was received and converted to text from step-1 is translated from one language to another. Again, for the preferred embodiment the software package used for this purpose was IBM's software package of “Language Translator For Text.” This software package is specifically marketed and sold by IBM™ for the development of text translation applications. However, any similar text translation software can be used of which there are several on the market or similar software can be written. However, either way the overall real time translator (150) invention behind the entire process of real time translator software (160) remains unchanged.

Step-3 Speak out the Converted Text

The final step is-text-to-speech. Once real time translator (150) completes the text translation, the last step is to convert back to speech and “speak out” the text in words of translated language.

Again, for the preferred embodiment the software package used for this purpose was the TTS Software Package™ by the Microsoft Corporation. This software package is specifically marketed and sold by Microsoft™ for the development of text-to-speech applications. However, any similar text-to-speech software can be used of which there are several on the market or similar software can be written. However, either way the overall real time translator (150) invention behind the entire process of real time translator software (160) remains unchanged.

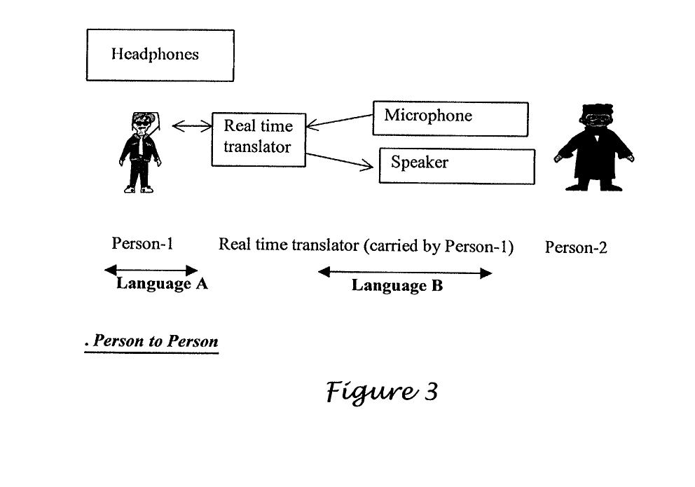

Referring to FIG. 3 there is shown Person-to-Person Communication via Conversation/Dialogue. When person-1 talks to person-2:

Real time translator hardware (151,152,153) (Portable Hardware configured for real time translator software (160))—running real time translator software (160). Attached with microphone/speaker (via headset or other) to sound card-1. Also attached to sound card-2 is another microphone/speaker (either free-standing or also via a headset). Sound card-1 and the corresponding microphone & speaker are used by person-1. Sound card-2 and the corresponding microphone & speaker are for the benefit of Person-2.

Person-1 speaks into microphone attached to sound card-1—those words (sentence) spoken in language-A, are received by the real time translator software (160) controlling input microphone (101), plus the conversion to text.

Real time translator software (160) controls input from microphone (101).

Real time translator software (160) and software controlled by it translates the language-A text to language-B text.

Real time translator software (160) switches control internally within real time translator (150) to sound card-2,

The previously translated words by real time translator (150) of language-B are converted to speech and “spoken out-loud” and are heard by Person-2 through the speaker attached to sound card-2.

The reverse applies when Person-2 either replies or talks to Person-1:

Sound card-2 and the corresponding microphone & speaker are for the benefit of Person-2.

Person-2 replies (or speaks) into microphone attached to sound card-2—those words spoken in language-B are received by the real time translator software (160) controlling input from microphone (201), plus the conversion to text.

Real time translator software (160) controls input from microphone (201).

Real time translator software (160) and Software controlled by it translates the language-B text to language-A text.

Real time translator software (160) switches control internally within real time translator (150) to sound card-1,

The previously translated words by real time translator (150) of language-A are converted to speech and “spoken out-loud” and are heard by Person-2 through the speaker attached to sound card-1.

This enables a two-way conversation between Persons 1 & 2 speaking languages A & B respectively. Each would speak to the other in their respective language and hear back from the other in their own language. It would be almost as if there was no difference of language. It would be a real-time one-on-one conversation face-to-face through the portability of real time translator (150).

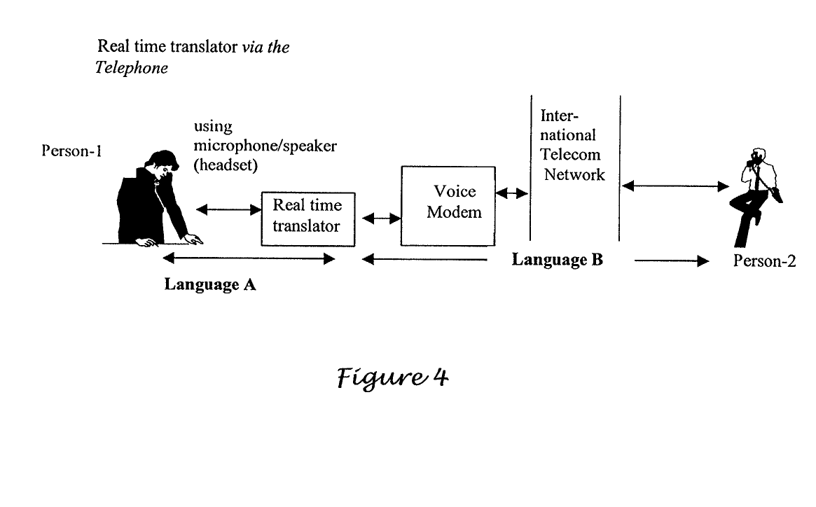

In another embodiment of Person-to-Person Telephone Communication as shown in FIG. 4 a telephone system or voice telecommunication system is used. Person-1 talks to Person-2 via the Telephone or similar telecommunication method:

Real time translator hardware (151,152,153) (Portable personal computer configured for real time translator software (160))—running real time translator software (160). Attached with Microphone/speaker (via headset or other) to sound card-1. Sound card-2 is attached to the normal, industry standard Voice Modem and the output from the Voice Modem is connected to a normal, standard telephone socket. No special connection is required at Person-2's location and s represented by a normal telephone acting as another Microphone/speaker. Therefore sound card-1 and the corresponding microphone & speaker are used by Person-1 and sound card-2 and the corresponding microphone & speaker (via telephone) are used by Person-2.

Dialing of the telephone number is done by person-1 using the Voice Modem and when a connection is made.

Person-1 speaks into microphone attached to sound card-1—and those words of language-A is received by the real time translator software (160) controlling input microphone (101), plus the conversion to text.

Real time translator software (160) controls input from microphone (101).

Real time translator software (160) and Software controlled by it translates the language-A text to language-B text.

Real time translator software (160) switches control internally within real time translator (150) to sound card-2.

The translated words of language-B are converted to speech and “spoken out-loud” through the telephone line, which, is attached to the sound card-2 and is heard by Person-2 via the speaker of the normal telephone handset. The telephone voice pulse/tone conversion is performed by the Voice Modem, as part of it normal functionality.

Person-2 replies or talks to Person-1 via the same telephone or similar telecommunication method:

A reply or other words spoken by Person-2 in language-B at the end of the Telephone line (or similar telecom device) is transmitted down the telephone line as normal and is input to sound card-2.

Real time translator software (160) controls input from microphone (201).

Real time translator software (160) and Software controlled by it translates the language-B text to language-A text.

Real time translator software (160) switches control internally within real time translator (150) to sound card-1,

The translated words by real time translator (150) of language-A are switched to sound card-1, converted to speech and “spoken” and heard by Person-1 via the speaker (headset or other) attached to sound card-1.

This enables a two-way conversation between persons 1 & 2 speaking languages A & B respectively over a normal standard telephone line. Each would speak to the other in their respective language and hear back from the other in their own language. It would be almost as if there was no difference of language. It would be a real-time one-on-one conversation face-to-face through the portability of real time translator (150) or via telephone by hooking it up to a telephone (as described below)

The use of a normal standard voice modem to connect real time translator hardware (151,152,153) (and thereby software) is to provide a simple solution for the conversion between speech and standard telephone pulse/tone. Also when used in different countries appropriate voice modems approved by the telecommunication authorities of each country can be used easily and effectively, instead of a specific built converter which must receive approval in each country.

As with the face-to-face scenario, when used over the telephone, person-2 at the other end does not require real time translator (150) or any special device, as real time translator (150) of person-1 performs all the work.

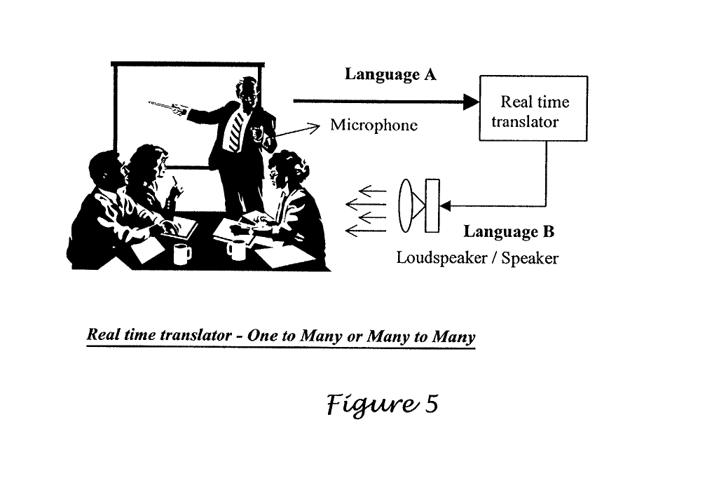

In a further embodiment of Person to Many Persons—in a speaker-to-audience or public address scenarios as shown in FIG. 5 person-1 talks to many persons (represented by person-2)

Real time translator hardware (151,152,153) (portable personal computer configured for real time translator software (160))—running real time translator software (160). Attach Microphone/speaker (via headset or stand alone) to sound card-1.

Attach sound card-2 another microphone/speaker (either free-standing or also via a headset) if audience participation required else to a loudspeaker or any other speaker/broadcast System. Sound card-1 and the corresponding microphone & speaker are used by Person-1 (the lecturer/speaker in the this instance. Sound card-2 and the corresponding microphone & speaker are for the benefit of Person(s)-2—the audience in this scenario.

Person-1 speaks into microphone attached to sound card-1—those words of language-A are received by the real time translator software (160) controlling input microphone (101), plus the conversion to text.

Real time translator software (160) controls input from microphone (101).

Real time translator software (160) and Software controlled by it translates the language-A text to language-B text.

Real time translator software (160) switches control internally within real time translator (150) to sound card-2,

The translated words by real time translator (150) of language-B are switched to sound card-2, converted to speech and “spoken out-loud” and are heard by the audience (Person-2) via the Loudspeaker/speaker attached to sound card-2.

### SUMMARY

The invention including the real time translator software (160) and hardware provides for an easy two-way conversation/dialogue between two (2) different languages at a single instance.

In a face-to-face conversation (through the portability of real time translator (150)).

In a conversation conducted over a standard telephone or telecommunication.

In a one to many dialogue, such as a speaker to audience situation.

In a one to many situation such as Radio, Television broadcasts & Public announcements.

In a many to many dialogue, such as over a conferencing system.

The special configuration requirement of the real time translator (150) is to add two sound cards. The same effect can also be obtained by coding to utilise the “left & right” channel invention of the single sound card but for the prototype the two sound card, approach was taken.

An embodiment of the invention can be built to be portable and will be specially built to be as small as possible and therefore easily carried by a person. Real time translator software (160) effectively breaks down the barriers of language. Whether it be English to Chinese or German to Japanese the difference of language and the inability to speak and establish a dialogue with someone unable to understand your own and only speaking a different language is changed forever by real time translator (150). Real time translator (150) is a companion and friend for the traveler and the tourist means and provides complete freedom. User can travel freely and easily from country to country and make themselves understood as well as to understand the spoken language—instantly and “on the spot”, without requiring to study or know any language at all

The real time translator (150) for the businessperson provides an effective means of communication. The invention also provides a commercial tool that provides for easy communication over the phone without the expensive and wasteful exercise of wasting time and money. No language barrier & the accompanying problems/frustrations, talk directly to clients, suppliers, and potential business contacts. Real time translator (150) provides for an effective tool in mass communications, and education presentations, when communication is required in a different language, as well as for government organizations requiring dealing with people speaking different languages.

1. In accordance with the invention there is provided a real time translator comprising:
(a) a voice receiver;
(b) a voice to text converter;
(c) a text-to-text spoken language converter for receiving a first language and translating to a second selected language;
(d) a text to voice converter for converting the translated second selected language to a voice output; and
(e) a voice emitter for emitting the voice output;
wherein the real time translator performs as a multilanguage conversation translator having dual voice paths operated by one or more sound cards and software so that conversation from one person in one spoken word language is translated and received by a second person in a second spoken word language at the same time or substantially at the same time as conversation from the second person in the second spoken word language is translated and received by the first person whereby the two persons can undertake a normal conversation in normal time but in different spoken word languages.

2. The translator according to claim 1, which is portable or hand-held or is an ear piece or the like.

3. The translator according to claim 1 which is attached to the telephone system or attached to a personal address system or the like.

4. A real time translator comprising:
(a) at least one voice receiver;
(b) at least one voice to text converter;
(c) at least one text to text spoken language converter for receiving a first selected language text and translating to a second selected language text and/or for receiving the second selected language text and translating to the first selected language text;
(d) at least one text to voice converter for converting the translated first and/or second selected language to a voice output; and
(e) at least one voice emitter for emitting the voice outputs.

5. The translator according to claim 4 wherein the real time translator includes two sound paths formed by two separate electronic sound manipulators with associated software such that the sound of the first voice in first language being received can be converted to text while the translated text into the second selected language is being converted to voice by the second separate electronic sound manipulator with associated software.

6. The translator according to claim 4 wherein the separate electronic sound manipulators are two personal computer sound cards or the like, or two separate left and right channels of a single personal computer sound card or the like with separate software control.

7. A portable real time translator comprising
(a) first and second voice receivers for receiving first and second selected voice languages;
(b) first and second voice to text converters;
(c) at least one text to text spoken language converter for receiving a first selected language text and translating to a second selected language text and/or for receiving the second selected language text and translating to the first selected language text;
(d) first and second voice converters for converting the translated first and second selected language to first and second voice outputs; and
(e) first and second voice emitters for emitting the voice outputs.

8. The translator according to claim 7 wherein there is an “overlap” in the processing of conversion of first and second voice conversions to or from text and/or with text to text voice language translation such that the lag time between receiving voice and emitting translated voice is within a reasonable conversation period with such period preferably less than one second to a maximum of two seconds.

9. The translator according to claim 8 wherein to simulate conversation the voice translation and emission is in voice phrases substantially corresponding with voice phrasing of input voice such that a continual flow of spaced voice phrases simulates conversations and preferably such voice phrases are a sentence or part of a sentence.

10. The translator according to claim 7 wherein there is an “overlap” in processing such that a first voice in a first language is received and translated and emitting translated voice simultaneously or apparently simultaneously with receiving a second voice in a second language and translating and emitting second translated voice and preferably by separate processing paths including the separate personal computer sound cards or the like or separate channels on a sound card or the like or by a switching system for switching between two processing paths at a rate to maintain reasonable real time processing of both paths simultaneously.

11. A method of providing real time translation of voices, the method including the steps of:
(a) providing first and second voice receivers for receiving first and second selected voice languages;
(b) providing first and second voice emitters associated with the first and second voice receivers respectively for emitting voice outputs;
(c) converting said first and second selected voice languages from said first and second voice receivers to text;
(d) providing a text to text spoken language converter for receiving a first selected language text from said first voice receiver and translating to a second selected language text and/or for receiving the second selected language text and translating to the first selected language text;
(e) providing a voice converter for converting the translated first and second selected language to first and second voice outputs; and
(f) emitting said translated and converted first and second voice outputs;
wherein there is parallel processing of the voice to text conversion and/or text translation and/or the text to voice conversion.

12. The translating method according to claim 11 wherein two sound cards or two channels operating separately on a sound card provide the first and second voice receivers and first and second voice emitters.

13. The translating method according to claim 11 wherein processing of the voice to text conversion and/or text translation and/or the text to voice conversion is by a central processing unit (cpu) or the like with software control of the sound card/s and preferably the parallel processing can be by central processing unit (cpu) parallel processing techniques or by software controlled switching techniques

14. The translating method according to claim 11 wherein processing of the voice to text conversion and/or text translation and/or the text to voice conversion is by switching between a speed of a voice phrase of about 2 seconds to the megahertz switching of the central processing unit (cpu).
